(19) United States
(12) Patent Application Publication
(10) Pub. No.: US 2024/0112864 A1
(43) Pub. Date: Apr. 4, 2024

(54) METHOD OF MANUFACTURING MULTILAYER ELECTRONIC COMPONENT

(71) Applicant: SAMSUNG ELECTRO-MECHANICS CO., LTD., Suwon-si (KR)

(72) Inventors: Yong PARK, Suwon-si (KR); Jung Tae PARK, Suwon-si (KR); Jong Ho LEE, Suwon-si (KR); Eun Jung LEE, Suwon-si (KR); Yong Min HONG, Suwon-si (KR); Jung Jin PARK, Suwon-si (KR); Rak Hyeon BAEK, Suwon-si (KR); Sun Mi KIM, Suwon-si (KR); Yong Ung LEE, Suwon-si (KR)

(73) Assignee: SAMSUNG ELECTRO-MECHANICS CO., LTD., Suwon-si (KR)

(21) Appl. No.: 18/219,854

(22) Filed: Jul. 10, 2023

(30) Foreign Application Priority Data
Sep. 30, 2022 (KR) 10-2022-0124826
Dec. 13, 2022 (KR) 10-2022-0173423

(51) Int. Cl. H01G 4/30

(52) U.S. Cl. CPC H01G 4/30

(57) ABSTRACT

A method of manufacturing a multilayer electronic component includes cutting a stack, in which internal electrode patterns and ceramic green sheets are alternately stacked in a stacking direction, to obtain unit chips and attaching a portion of a ceramic green sheet for a side margin portion to the unit chips in a direction, different from the stacking direction. The attaching includes attaching the portion of the ceramic green sheet to the unit chips by compression between a first elastic body on which the ceramic green sheet is disposed and the unit chips. The first elastic body includes a first elastic layer having and a second elastic layer having an elastic modulus different from the first elastic layer, and disposed between the unit chips and the first elastic layer. An elastic modulus of the first elastic body is greater than 50 MPa and less than or equal to 1000 MPa.

### CROSS-REFERENCE TO RELATED APPLICATION(S)

This application claims the benefit under 35 USC 119(a) of Korean Patent Application Nos. 10-2022-0124826 filed on Sep. 30, 2022 and 10-2022-0173423 filed on Dec. 13, 2022, in the Korean Intellectual Property Office, the entire disclosures of which are incorporated herein by reference for all purposes.

### TECHNICAL FIELD

The present disclosure relates to a method of manufacturing a multilayer electronic component.

### BACKGROUND

A multilayer ceramic capacitor (MLCC), a multilayer electronic component, is a chip-type capacitor mounted on the printed circuit boards of various types of electronic products such as imaging devices including liquid crystal displays (LCDs) and plasma display panels (PDPs), computers, smartphones, cell phones, and the like, to allow electricity to be charged therein and discharged therefrom.

In the related art, as a method of increasing the capacitance, while miniaturizing multilayer ceramic capacitors, a process of exposing internal electrodes in a width direction of a body to maximize the area of the internal electrodes in the width direction through a marginless design and separately attaching side margin portions to the exposed surface of the internal electrodes in the width direction of a unit chip in an operation before sintering, after a unit chip is manufactured, is applied.

### SUMMARY

Exemplary embodiments provide a method of manufacturing a multilayer electronic component capable of efficiently forming a side margin portion in the multilayer electronic component. For example, the occurrence of defects in the process of attaching the side margin portion to the multilayer electronic component may be effectively prevented.

According to an exemplary embodiment, a method of manufacturing a multilayer electronic component includes: cutting a stack, in which a plurality of internal electrode patterns and a plurality of ceramic green sheets are alternately stacked in a stacking direction, in the stacking direction to obtain a plurality of unit chips; and attaching a portion of a ceramic green sheet for a side margin portion to the plurality of unit chips in a direction, different from the stacking direction. The attaching includes attaching the portion of the ceramic green sheet for a side margin portion to the plurality of unit chips by compression between a first elastic body on which the ceramic green sheet for a side margin portion is disposed and the plurality of unit chips. The first elastic body includes a first elastic layer having a first elastic modulus and a second elastic layer having a second elastic modulus, different from the first elastic modulus, and disposed between the plurality of unit chips and the first elastic layer. An elastic modulus of the first elastic body is greater than 50 MPa and less than or equal to 1000 MPa.

According to another exemplary embodiment, a method of manufacturing a multilayer electronic component includes: cutting a stack, in which a plurality of internal electrode patterns and a plurality of ceramic green sheets are alternately stacked in a stacking direction, in the stacking direction to obtain a plurality of unit chips; and attaching a portion of a ceramic green sheet for a side margin portion to the plurality of unit chips in a direction, different from the stacking direction. The attaching includes attaching the portion of the ceramic green sheet for a side margin portion to the plurality of unit chips by compression between a first elastic body on which the ceramic green sheet for a side margin portion is disposed and the plurality of unit chips. The first elastic body includes a first elastic layer having a first elastic modulus and a second elastic layer having a second elastic modulus, different from the first elastic modulus, and disposed between the plurality of unit chips and the first elastic layer. The attaching further includes rotating the plurality of unit chips disposed on a second elastic body before the ceramic green sheet for a side margin portion is disposed on the first elastic body. The second elastic body includes a third elastic layer having a third elastic modulus and a fourth elastic layer having a fourth elastic modulus, different from the third elastic modulus, and disposed between the plurality of unit chips and the third elastic layer.

According to another exemplary embodiment, a method of manufacturing a multilayer electronic component includes: cutting a stack, in which a plurality of internal electrode patterns and a plurality of ceramic green sheets are alternately stacked in a stacking direction, in the stacking direction to obtain a plurality of unit chips; and attaching a portion of a ceramic green sheet for a side margin portion to the plurality of unit chips in a direction, different from the stacking direction. The attaching includes attaching the portion of the ceramic green sheet for a side margin portion to the plurality of unit chips by compression between a first elastic body on which the ceramic green sheet for a side margin portion is disposed and the plurality of unit chips. The first elastic body includes a first elastic layer having a first elastic modulus and a second elastic layer having a second elastic modulus, different from the first elastic modulus, and disposed between the plurality of unit chips and the first elastic layer. The attaching includes attaching the portion of the ceramic green sheet for a side margin portion to the plurality of unit chips by compression between the first elastic body and a second elastic body, after the plurality of unit chips are disposed between the first elastic body and the second elastic body. The second elastic body includes a third elastic layer having a third elastic modulus and a fourth elastic layer having a fourth elastic modulus, different from the third elastic modulus, and disposed between the plurality of unit chips and the third elastic layer.

### BRIEF DESCRIPTION OF DRAWINGS

The above and other aspects, features, and advantages of the present inventive concept will be more clearly understood from the following detailed description, taken in conjunction with the accompanying drawings, in which:

FIG. 1 is a perspective view schematically illustrating a multilayer electronic component that may be manufactured by a method of manufacturing a multilayer electronic component according to an exemplary embodiment in the present disclosure;

FIG. 2 is a cross-sectional view taken along line I-I′ of FIG. 1;

FIG. 3 is a cross-sectional view taken along line II-II′ of FIG. 1;

FIG. 4 is an exploded perspective view schematically illustrating a stacking operation of obtaining a plurality of unit chips according to an exemplary embodiment in the present disclosure;

FIG. 5 is a perspective view schematically illustrating a cutting operation of obtaining a plurality of unit chips according to an exemplary embodiment in the present disclosure;

FIG. 6 is a perspective view schematically illustrating a shape of a plurality of unit chips immediately after performing a cutting operation of obtaining a plurality of unit chips according to an exemplary embodiment in the present disclosure;

FIG. 7 is a plan view of a plurality of unit chips viewed from a first direction immediately after performing a cutting operation of obtaining a plurality of unit chips according to an exemplary embodiment in the present disclosure;

FIG. 8 is a perspective view schematically illustrating the shape of a unit chip according to an exemplary embodiment in the present disclosure;

FIG. 9 is a side view schematically illustrating a rotating operation of an attaching operation according to an exemplary embodiment in the present disclosure;

FIG. 10 is a side view schematically illustrating a close-up operation of an attaching operation according to an exemplary embodiment in the present disclosure;

FIG. 11 is a side view schematically illustrating a punching operation of an attaching operation according to an exemplary embodiment in the present disclosure;

FIG. 12 is a side view schematically illustrating a finishing operation of an attaching operation according to an exemplary embodiment in the present disclosure;

FIG. 13 is a view illustrating a stress-strain curve for analyzing a method of measuring an elastic modulus of materials that may be included in first, second, third, and fourth elastic layers;

FIG. 14 is a graph illustrating a method of measuring elastic modulus of materials having linear elastic behavior, such as polyethylene terephthalate (PET);

FIG. 15 is a graph illustrating a method of measuring elastic modulus of materials having nonlinear elastic behavior, such as nonwoven fabric; and

FIG. 16 is a graph illustrating elastic moduli of materials that may be included in first, second, third, and fourth elastic layers.

### DETAILED DESCRIPTION

Hereinafter, exemplary embodiments of the present inventive concept will be described in detail with reference to the accompanying drawings. The inventive concept may, however, be exemplified in many different forms and should not be construed as being limited to the specific exemplary embodiments set forth herein. Rather, these exemplary embodiments are provided so that this disclosure will be thorough and complete, and will fully convey the scope of the inventive concept to those skilled in the art. In the drawings, the shapes and dimensions of elements may be exaggerated for clarity, and the same reference numerals will be used throughout to designate the same or like elements.

To clarify the present disclosure, portions irrespective of description are omitted and like numbers refer to like elements throughout the specification, and in the drawings, the thickness of layers, films, panels, regions, etc., are exaggerated for clarity. Also, in the drawings, like reference numerals refer to like elements although they are illustrated in different drawings. Throughout the specification, unless explicitly described to the contrary, the word “comprise” and variations, such as “comprises” or “comprising,” will be understood to imply the inclusion of stated elements but not the exclusion of any other elements.

In the drawings, a first direction may be defined as a direction in which a plurality of ceramic green sheets are stacked or a thickness (T) direction, a second direction may be defined as a length (L) direction, and a third direction may be defined as a width (W) direction. The second direction and the third direction may be, perpendicular to the first direction.

Referring to 4 to 8, a method of manufacturing a multilayer electronic component according to an exemplary embodiment in the present disclosure may include cutting a stack 200 in which a plurality of internal electrode patterns 221 and 222 and a plurality of ceramic green sheets 201 and 202 are alternately stacked in a stacking direction (e.g., the first direction) to obtain a plurality of unit chips 210. A bar 300 may include a structure in which the stack 200 is disposed on a support film 310.

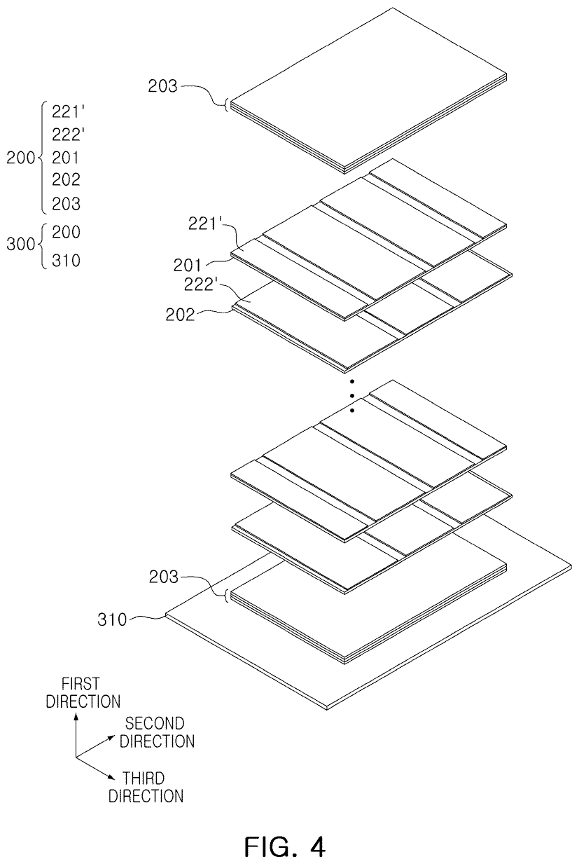

Referring to FIG. 4, the support film 310 may serve to support the stack 200 in which conductive patterns 221′ and 222′ and the plurality of ceramic green sheets 201 and 202 are stacked. For example, the support film 310 may include adhesive materials, such as latex, starch, cellulose, protein, isoprene rubber (IR), nitrile butadiene rubber (NBR), styrene butadiene rubber (SBR), and mixtures thereof. The support film 310 may be parallel to the ground, but is not limited thereto.

The plurality of ceramic green sheets 201 and 202 may be formed of a ceramic paste including ceramic powder, an organic solvent, a dispersing agent, and a binder. The ceramic powder is a raw material for forming a dielectric layer 111 of the multilayer electronic component 100, and a barium titanate-based material, a lead composite perovskite-based material, or a strontium titanate-based material may be used. The barium titanate-based material may include BaTiO₃-based ceramic powder, and examples of the ceramic powder may include BaTiO₃, and (Ba₁₋ₓCaₓ) TiO₃ (0<x<1), Ba (Ti_{1-y}Ca_{y}) O₃ (0<y<1), (Ba₁₋ₓCaₓ) (Ti_{1-y}Zr_{y}) O₃ (0<x<1, 0<y<1), or Ba (Ti_{1-y}Zr_{y}) O₃ (0<y<1), in which calcium (Ca), zirconium (Zr), or the like is partially dissolved. The plurality of ceramic green sheets 201 and 202 may be sintered to become the dielectric layer 111 constituting a body 110.

Meanwhile, in an exemplary embodiment, the stack 200 may further include a ceramic green sheet 203 for a cover portion forming cover portions 112 and 113. The ceramic green sheet 203 for a cover portion may be formed of the same material and component as those of the ceramic green sheets 201 and 202, but is not limited thereto, and the upper and lower cover portions 112 and 113 of the body 110 may be formed through a sintering process. For example, the ceramic green sheets 203 for a cover portion may be formed on one surface and the other surface of the stack in the first direction, and may be formed as a single layer or a plurality of layers.

The internal electrode patterns 221 and 222 may be formed on the ceramic green sheets 201 and 202 by using an internal electrode paste including a conductive metal. The conductive metal included in the internal electrode patterns 221 and 222 is not particularly limited, and materials having excellent electrical conductivity may be used. For example, the conductive metal may include one or more of nickel (Ni), copper (Cu), palladium (Pd), silver (Ag), gold (Au), platinum (Pt), tin (Sn), tungsten (W), titanium (Ti), and alloys thereof. A method of forming the internal electrode patterns 221 and 222 on the ceramic green sheets 201 and 202 is not particularly limited. For example, a conductive paste for an internal electrode including the conductive metal may be formed on the ceramic green sheets 201 and 202 by screen-printing or gravure printing.

The internal electrode patterns 221 and 222 may have a stripe shape. Specifically, the internal electrode patterns 221 and 222 may be formed to contact both ends of the ceramic green sheets 201 and 202 in the third direction at regular intervals in the second direction.

The internal electrode patterns 221 and 222 may include a first internal electrode pattern 221 formed on the ceramic green sheet 201 and a second internal electrode pattern 222 formed on the other ceramic green sheet 202. At this time, the ceramic green sheet on which the first internal electrode pattern 221 is formed may be referred to as a first ceramic green sheet 201, and the ceramic green sheet on which the second internal electrode pattern 222 is formed may be referred to as a second ceramic green sheet 202.

As shown in FIG. 4, the plurality of ceramic green sheets 201 and 202 may be alternately stacked such that the first internal electrode patterns 221 and the second internal electrode patterns 222 are alternately stacked. Accordingly, when the unit chip 210 to be described below is formed, the first internal electrode pattern 221 may be exposed from the third surface 3 and the second internal electrode pattern 222 may be exposed from the fourth surface 4. The first internal electrode pattern 221 may become the first internal electrode 121 after sintering, and the second internal electrode pattern 222 may become the second internal electrode 122 after sintering.

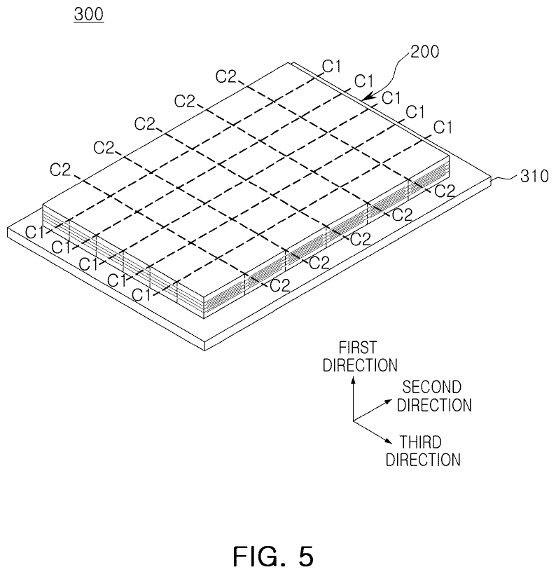

Referring to FIGS. 5 to 7, when a direction in which the plurality of ceramic green sheets 201 and 202 are stacked with respect to the bar 300 is referred to as the first direction, the bar 300 may be cut once or more times in the second direction, perpendicular to the first direction, and may be cut once or more times in the third direction, perpendicular to the first and second directions, to obtain a plurality of unit chips 210, and in this case, the internal electrode patterns 221 and 222 may be connected to both first and second side surfaces S1 and S2 of the unit chip 210.

As shown in FIG. 5, the stack 200 may be cut along cutting lines C1-C1 and C2-C2 orthogonal to each other. The cutting lines C1-Cl are cutting lines, parallel to the second direction, and are substantially equally spaced in the third direction, and the cutting lines C2-C2 are cutting lines, parallel to the third direction, and are substantially equally spaced in the second direction. The unit chip 210 having a substantially constant size in the third direction may be formed by the cutting line C1-C1, and the unit chip 210 having a substantially constant size in the second direction may be formed by the cutting line C2-C2.

In particular, since the cutting line C2-C2 cuts the center of the first and second internal electrode patterns 221 and 222 in the second direction and a space in which the first and second internal electrode patterns 221 and 222 are spaced apart from each other in the second direction, the first internal electrode pattern 221 of the unit chip 210 may be exposed from the third surface 3 and the second internal electrode pattern 222 of the unit chip 210 may be exposed from the fourth surface 4.

A unit for cutting the stack 200 is not particularly limited. For example, the stack 200 may be cut using a blade cutting method, such as a doctor blade or a dicing blade, a guillotine cutting method, or a laser cutting method.

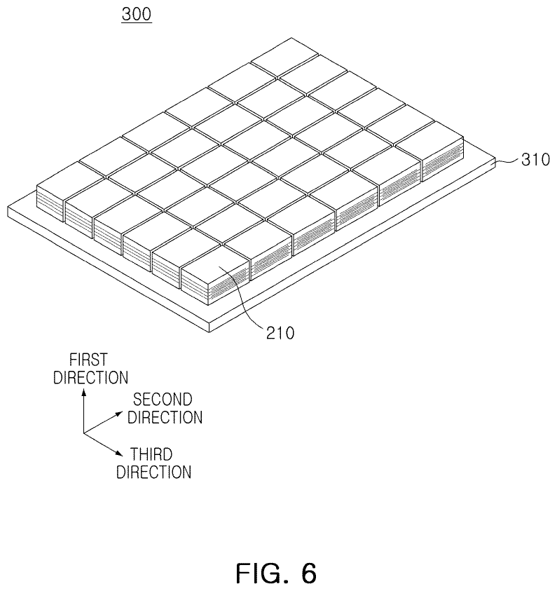

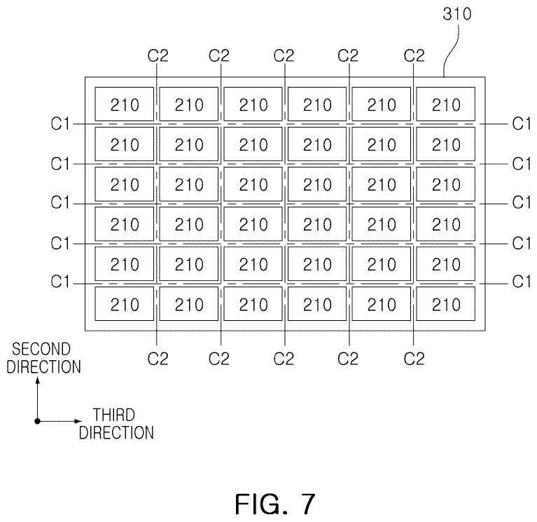

Referring to FIGS. 6 and 7, when the bar 300 is cut, the stack 200 may be divided into a plurality of unit chips 210. Even after being cut, the plurality of unit chips 210 may be adhered to the support film 310 due to adhesiveness of the support film 310.

FIGS. 6 and 7 show a structure in which a plurality of unit chips 210 are separated from each other at regular intervals by cutting, but the plurality of unit chips 210 may be substantially in contact with each other due to viscosity of the plurality of ceramic green sheets 201 and 202 and the internal electrode patterns 221 and 222 in a state in which adhesive force therebetween weakens.

However, it is not excluded that the plurality of unit chips are spaced apart from each other, and a size of space between the plurality of unit chips may be smaller than a size of space in which adjacent unit chips may rotate without coming into contact with each other.

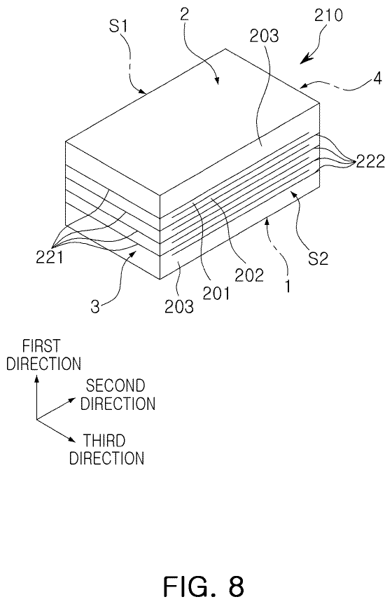

Referring to FIG. 8, the internal electrode patterns 221 and 222 of the plurality of unit chips 210 according to an exemplary embodiment in the present disclosure are cut so that the first and second side surfaces S1 and S2 of the unit chip 210 facing each other are all connected. Accordingly, an area in which the internal electrode patterns 221 and 222 may be formed may be maximized, thereby improving capacitance per unit volume of the multilayer electronic component 100. However, the first and second side surfaces S1 and S2 from which the internal electrode patterns 221 and 222 are exposed are vulnerable to external moisture penetration, and if external electrodes to be described below are formed to extend to the first and second side surfaces S1 and S2, there may be a risk of short circuit.

In the attaching operation of an exemplary embodiment in the present disclosure, which will be described below, a first side margin portion may be formed by attaching a ceramic green sheet for a side margin portion to the first side surface S1 and/or the second side surface S2 and punching the same, thereby resolving the problem of moisture resistance reliability and short-circuiting.

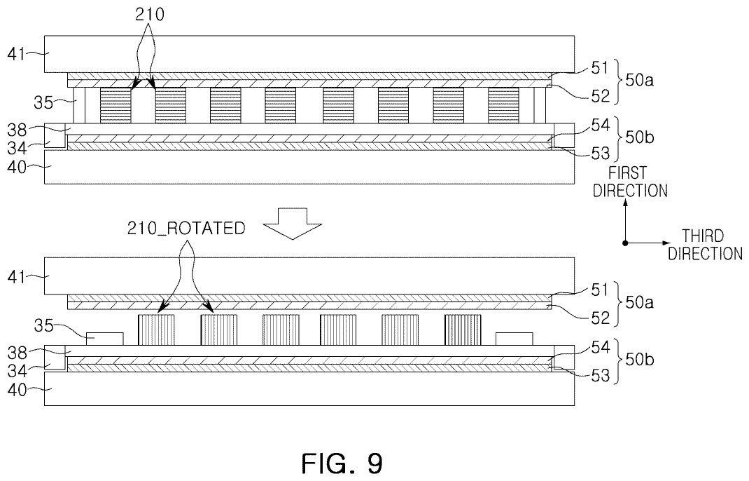

Referring to FIGS. 9 to 12, the method of manufacturing a multilayer electronic component according to an exemplary embodiment in the present disclosure may include an operation of attaching a plurality of first portions 47a of ceramic green sheets 47 for a side margin portion to the plurality of unit chips 210 in a direction (e.g., the third direction of FIG. 8), different from the stacking direction (e.g., the first direction of FIG. 8) of the stack 200.

The plurality of first portions 47a may be portion of the ceramic green sheet 47 for a side margin portion. The attaching operation may include attaching the plurality of first portions 47a to the plurality of unit chips 210, while cutting the plurality of first portions 47a and second portions 47b of the ceramic green sheet 47 for a side margin portion, by compressing a first elastic body 50d in which the ceramic green sheet 47 for a side margin portion is disposed and the plurality of unit chips 210. It may include attaching the plurality of first portions 47a to the plurality of unit chips 210 while cutting between the portions 47a and the second portions 47b. This may be expressed as punching.

As the elastic modulus of the first elastic bodies 50a and 50d is lower, a shape of the first elastic bodies 50a and 50d may be more easily deformed by an external force and damage to the plurality of unit chips 210 in the process of attaching the plurality of first portions 47a to the plurality of unit chips 210 may be effectively suppressed.

As the elastic modulus of the first elastic bodies 50a and 50d is higher, the shape of the first elastic bodies 50a and 50d may be maintained more strongly, and cutting defects in the process of cutting between the plurality of first portions 47a and the second portions 47b may be effectively suppressed.

Therefore, when the elastic modulus of the first elastic bodies 50a and 50d is optimized, damage to the plurality of unit chips 210 in the process of attaching the plurality of first portions 47a to the plurality of unit chips 210 and cutting defects in the process of cutting between the plurality of first portions 47a and the second portions 47b may be effectively suppressed.

The first elastic bodies 50a and 50d may include a first elastic layer 51 having a first elastic modulus and a second elastic layer 52 having a second elastic modulus, different from the first elastic modulus, and disposed between at least one of a plurality of unit chips 210 and the first elastic layer 51. Accordingly, the elastic modulus of the first elastic bodies 50a and 50d may be more advantageously optimized.

The elastic modulus of the first elastic bodies 50a and 50d may be measured by directly measuring the elastic modulus of the first elastic bodies 50a and 50d, and may be substantially the same as an interpolation elastic modulus. The interpolation elastic modulus may be calculated as a value obtained by obtaining the sum (a third value) of a product (a first value) of a volume of the first elastic layer 51 and the first elastic modulus and a product (a second value of a volume of the second elastic layer 52 and the second elastic modulus and then dividing the sum (the third value) by the sum (a fourth value) of the volume of the first elastic layer 51 and the volume of the second elastic layer 52. That is, the sum of the first value and the second value is the third value, and the value obtained by dividing the third value by the fourth value may be the elastic modulus of the first elastic bodies 50a and 50d.

The elastic modulus of the first elastic bodies 50a and 50d may be an overall elastic modulus of the first and second elastic layers 51 and 52, and may be greater than 50 Mpa and less than 1000 MPa. Since the elastic modulus of the first elastic bodies 50a and 50d exceeds 50 MPa, cutting defects in the process of cutting between the plurality of first portions 47a and second portions 47b may be effectively suppressed. Since the elastic modulus of the first elastic bodies 50a and 50d is 1000 MPa or less, damage to the plurality of unit chips 210 in the process of attaching the plurality of first portions 47a to the plurality of unit chips 210 may be effectively suppressed.

The attaching operation may include attaching the plurality of first portions 47a to the plurality of unit chips 210 by compression between the first elastic bodies 50a and 50d and the second elastic bodies 50b and 50c, after the plurality of unit chips 210 are disposed between the first elastic bodies 50a and 50d and the second elastic bodies 50b and 50c. The second elastic bodies 50b and 50c may include a third elastic layer 53 having a third elastic modulus and a fourth elastic modulus having a fourth elastic module, different from the third elastic modulus, and disposed between at least one of the plurality of unit chips 210 and the third elastic layer 53.

Accordingly, since the elastic modulus of the second elastic bodies 50b and 50c may be more advantageously optimized, damage to the plurality of unit chips 210 in the process of attaching the plurality of first portions 47a to the plurality of unit chips 210 and cutting defects in the process of cutting between the plurality of first portions 47a and the second portions 47b may be suppressed more efficiently. The first elastic modulus and the third elastic modulus may be the same as or different from each other. The second elastic modulus and the fourth elastic modulus may be the same as or different from each other.

For example, each of the first, second, third, and fourth elastic moduli may exceed 50 MPa. Accordingly, cutting defects in the process of cutting between the plurality of first portions 47a and the second portions 47b may be stably suppressed.

For example, the second elastic modulus may be higher than the first elastic modulus, a thickness of the first elastic layer 51 may be greater than a thickness of the second elastic layer 52, the fourth elastic modulus may be greater than the third elastic modulus, and a thickness of the third elastic layer 53 may be greater than a thickness of the fourth elastic layer 54. Accordingly, the first elastic layer 51 and/or the third elastic layer 53 may efficiently serve as a buffer for the plurality of unit chips 210, and the second elastic layer 52 and/or the fourth elastic layer 54 may efficiently perform a role of cutting between the plurality of first portions 47a and second portions 47b.

For example, each of the first, second, third, and fourth elastic layers 51, 52, 53, and 54 may have a thickness greater than 0 μm and less than or equal to 3 μm. For example, a hardness value of each of the first elastic bodies 50a and 50d and the second elastic bodies 50b and 50c may be 100 or less. For example, upper and lower surfaces of each of the first, second, third, and fourth elastic layers 51, 52, 53, and 54 may be 500 mm*500 mm or less.

For example, since nonwoven fabric may have an elastic modulus lower than that of polyethylene terephthalate (PET), the nonwoven fabric may be included in each of the first and third elastic layers 51 and 53. Each of the second and fourth elastic layers 52 and 54 may include PET. Here, the thickness of each of the first and third elastic layers 51 and 53 may be greater than 0 μm and less than or equal to 2 μm, and the thickness of each of the second and fourth elastic layers 52 and 54 may be greater than 0 μm and less than or equal to 1 μm.

For example, each of the first, second, third, and fourth elastic layers 51, 52, 53, and 54 may replace or may further include at least one of silicone, polyurethane (PU), natural rubber, and polyolefine (PO), as well as non-woven fabric and PET. For example, silicone may be silicone rubber, and the elastic modulus of the silicone rubber may be 60 MPa or more and 80 MPa or less.

Roughness of a surface of the second elastic layer 52 facing the ceramic green sheet 47 for a side margin portion may be greater than roughness of the surfaces of the first and second elastic layers 51 and 52 facing each other. Roughness of the surface of the fourth elastic layer 54 facing at least one of the plurality of unit chips 210 may be greater than roughness of the surfaces of the third and fourth elastic layers 53 and 54 facing each other. Accordingly, in the process of attaching the plurality of first portions 47a to the plurality of unit chips 210, the ceramic green sheet 47 for a side margin portion or the plurality of unit chips 210 may be effectively prevented from slipping sideways. For example, in order to implement a roughness difference between upper and lower surfaces of the second and fourth elastic layers 52 and 54, respectively, a known roughness treatment process may be applied to only one of the upper and lower surfaces of the second and fourth elastic layers 52 and 54.

Referring to FIG. 9, the attaching operation may further include rotating the plurality of unit chips 210 disposed on the second elastic body 50b before the ceramic green sheet for a side margin portion is disposed on the first elastic body, and the second elastic body 50b may include the third elastic layer 53 having the third elastic modulus and the fourth elastic layer 54 disposed between at least one of the plurality of unit chips 210 and the third elastic layer 53 and having the fourth elastic modulus, different from the third elastic modulus.

For example, the plurality of unit chips 210 may be disposed on a support 40 together with an adhesive sheet 38, and a plate 41 may be disposed above the plurality of unit chips 210. Thereafter, the plate 41 may tumble in a horizontal direction. Since the adhesive sheet 38 may tumble together with the plate 41 by a connection portion 34, the plurality of unit chips 210 on the adhesive sheet 38 may be rotated by 90 degrees all together. At this time, the support 35 supporting between the support 40 and the plate 41 may also tumble.

As the elastic modulus of the first elastic body 50a and/or the second elastic body 50b is lower, the first elastic body 50a and/or the second elastic body 50b may serve to buffer against transfer of stress based on the tumbling of the plate 41 to the plurality of unit chips 210, thereby preventing damage to the plurality of unit chips 210. As the elastic modulus of the first elastic body 50a and/or the second elastic body 50b is higher, rotation defects of the plurality of unit chips 210 may be prevented.

Since the first elastic body 50a may include first and second elastic layers 51 and 52 respectively having different first and second elastic moduli, the elastic modulus of the first elastic body 50a may be efficiently optimized. Since the second elastic body 50b may include the third and fourth elastic layers 53 and 54 respectively having the third and fourth elastic moduli different from each other, the elastic modulus of the second elastic body 50b may be efficiently optimized. By optimizing the elastic moduli of the first elastic body 50a and/or the second elastic body 50b, rotation of the plurality of unit chips 210 may be stably performed and damage to the plurality of unit chips 210 may be efficiently prevented.

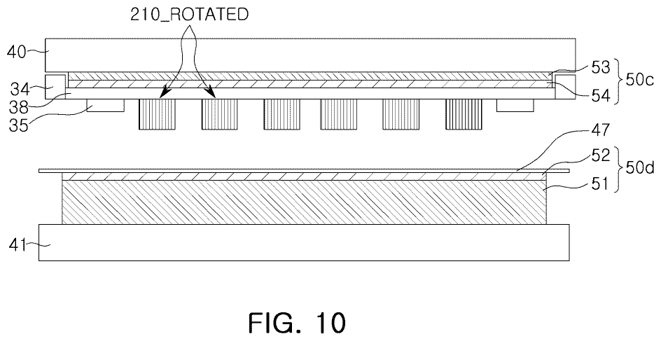

Meanwhile, the first elastic body 50a of FIG. 9 and the first elastic body 50d of FIGS. 10 to 12 may be the same as or different from each other. The second elastic body 50b of FIG. 9 and the second elastic body 50c of FIGS. 10 to 12 may be the same as or different from each other.

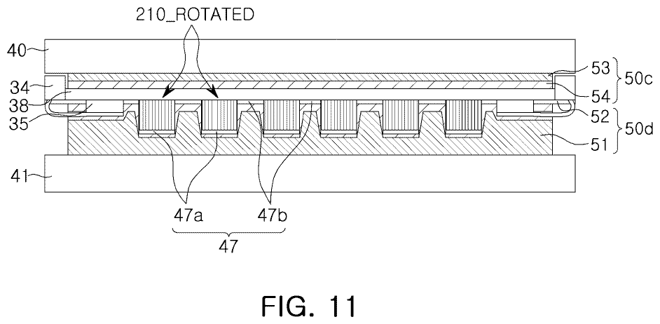

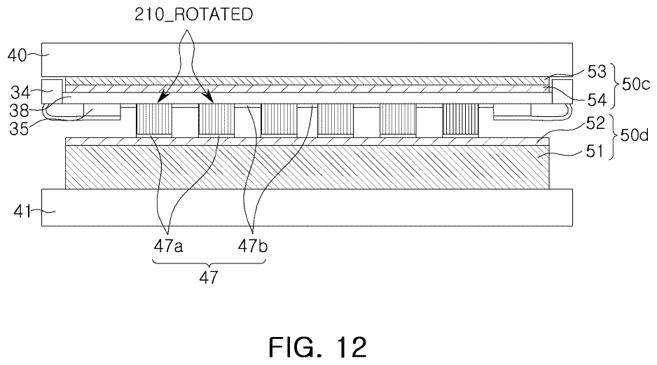

Referring to FIGS. 10 to 12, the attaching operation may include a proximity operation shown in FIG. 10, a punching operation shown in FIG. 11, and a finishing operation shown in FIG. 12, which are sequentially performed.

Referring to FIGS. 10 to 12, the ceramic green sheet 47 for a side margin portion may be formed of ceramic powder including a barium titanate-based material, a lead composite perovskite-based material, or a strontium titanate-based material, an organic solvent, a dispersing agent, and a binder, like the ceramic green sheets 201 and 202 described above. However, the ceramic green sheet 47 for a side margin portion does not necessarily have the same composition as that of the ceramic green sheets 201 and 202 described above, and may have a different composition. Accordingly, the margin portions 114 and 115 after sintering may have a dielectric average particle size, density, or hardness different from that of the dielectric layer 111.

For example, an ambient temperature in the attaching operation may be adjusted to 50° C. to 150° C. to prevent deformation and/or cracking of the ceramic green sheet 47 for a side margin portion. This may be expressed as thermocompression bonding. Alternatively, the ambient temperature in the attaching operation may be adjusted to 50° C. or less to prevent drying of the ceramic green sheet 47 for a side margin portion.

For example, an adhesive (e.g., acrylic, epoxy) may be disposed between the second elastic layer 52 and the plate 41 and may be disposed between the fourth elastic layer 54 and the support 40.

For example, the sintering process may be performed on the plurality of unit chips 210 to which the plurality of first portions 47a are attached. The sintering process may be performed at a temperature of 1000 to 1300° C. in a reducing atmosphere, but is not limited thereto. Thereafter, external electrodes 131 and 132 may be formed on the third and fourth surfaces 3 and 4 of the body 110, respectively, to form the multilayer electronic component 100.

Meanwhile, the unit chip 210 on which first and second side margin portions 214 and 215 are formed may be sintered to form the body 110 without an additional process, but is not limited thereto, and a conductive paste including a metal having excellent electrical conductivity may be disposed on each of the third and fourth surfaces 3 and 4 and simultaneously sintered together with the body 110 to form the external electrodes 131 and 132 to manufacture the multilayer electronic component 100.

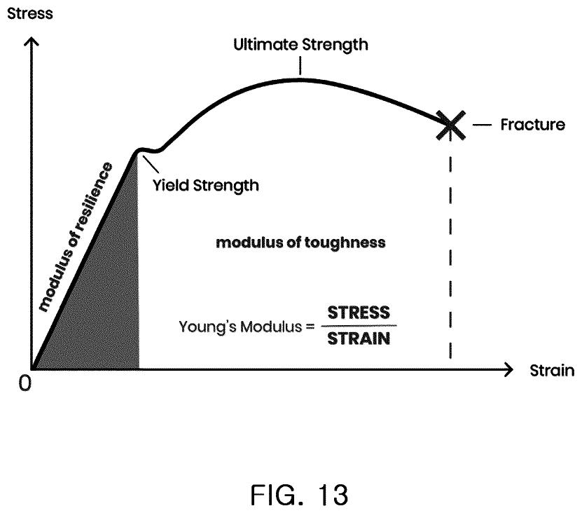

The vertical and horizontal axes of the stress-strain curve in FIG. 13 represent stress and strain, respectively. When stress starts to be applied to the first elastic body and/or the second elastic body, strain may increase linearly within a range of modulus of resilience. In this case, the slope of the curve may correspond to the elastic modulus.

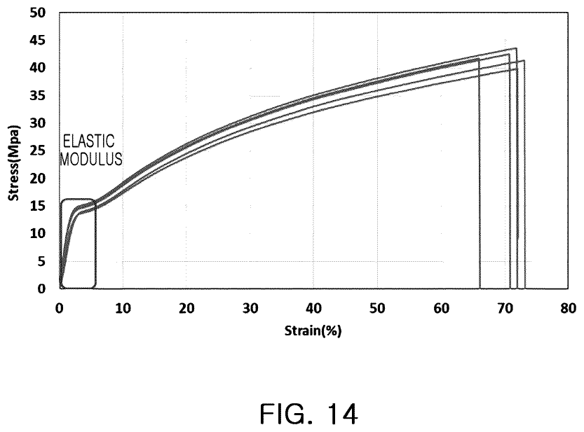

The five curves in FIG. 14 represent 5 stress-strain curves obtained by measuring a PET sample five times, and the elastic modulus of PET having linear elastic behavior may be measured as an average value of the slopes of the stress-strain curves within the linear range in the five measurements.

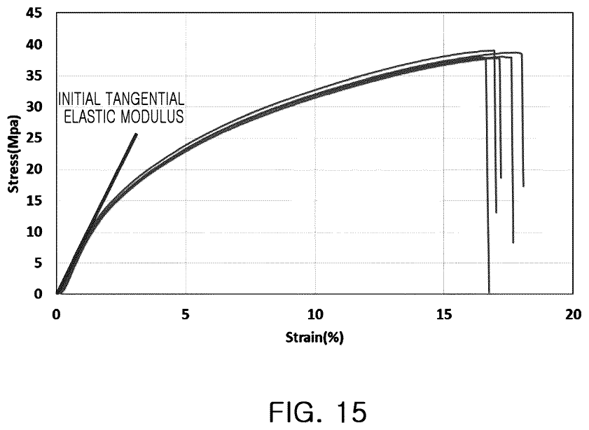

The five curves in FIG. 15 represent the five stress-strain curves obtained by measuring nonwoven fabric sample five times, and the elastic modulus of the nonwoven fabric having a nonlinear elastic behavior may be measured as an average value of initial tangential slopes of the stress-strain curves of the five measurements.

The ten stress-strain curves of FIGS. 14 and 15 were obtained by a TIRA tension measuring instrument, a shape of the sample was a plate shape, and an area of upper and lower surfaces of the plate was 5 mm*5 mm.

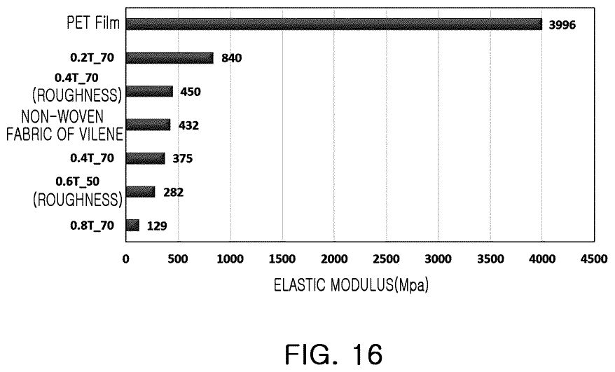

The elastic moduli in FIG. 16 were organized according to the measured values in Table 1 below. Here, 0.8T_70, 0.6T_50 (roughness), 0.4T_70, 0.4T_70 (roughness), and 0.2T_70 may respectively correspond to the first elastic body including the first and second elastic layers and may include a structure in which the material or volume ratio included in the first and second elastic layers is adjusted to be different from each other.

TABLE 1

| | | 0.6T_50 | | 0.4T_70 | | Non-woven | |
|---|---|---|---|---|---|---|---|
| | | (Rough- | 0.4T_ | (Rough- | 0.2T_ | fabric of | PET |
| | 0.8T_70 | ness) | 70 | ness) | 70 | Vilene | Film |
| Measure- | 120 | 240 | 411 | 420 | 660 | 390 | 4200 |
| ment 1 | | | | | | | |
| Measure- | 130 | 360 | 390 | 330 | 630 | 420 | 4080 |
| ment 2 | | | | | | | |
| Measure- | 136 | 270 | 390 | 480 | 990 | 420 | 3600 |
| ment 3 | | | | | | | |
| Measure- | 130 | 300 | 330 | 510 | 960 | 480 | 3900 |
| ment 4 | | | | | | | |
| Measure- | 129 | 240 | 354 | 510 | 960 | 450 | 4200 |
| ment 5 | | | | | | | |
| Minimum | 120 | 240 | 330 | 330 | 630 | 390 | 3600 |
| value | | | | | | | |
| Maximum | 136 | 360 | 411 | 510 | 990 | 480 | 4200 |
| value | | | | | | | |
| Average | 129 | 282 | 375 | 450 | 840 | 432 | 3996 |
| value | | | | | | | |

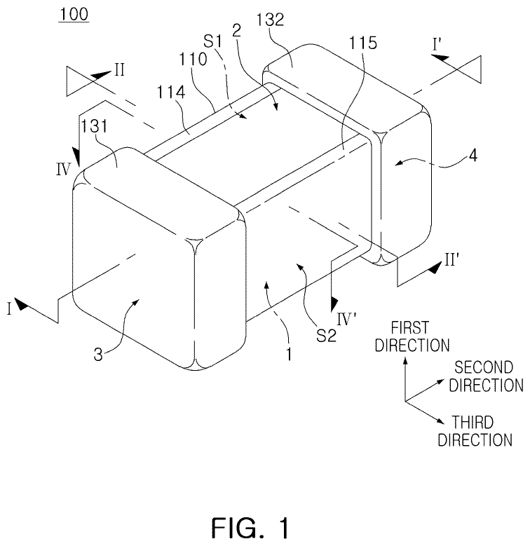

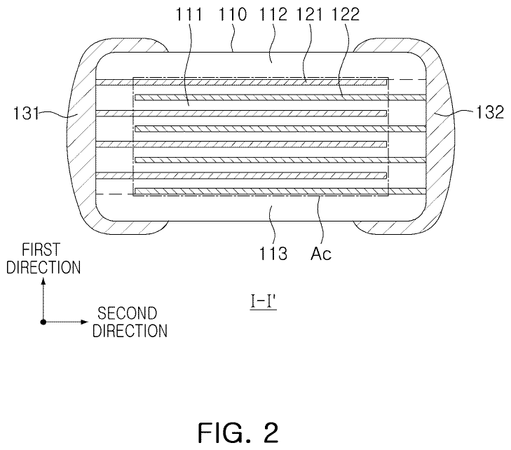

Hereinafter, the multilayer electronic component 100 that may be manufactured by a manufacturing method according to an exemplary embodiment in the present disclosure will be described with reference to FIGS. 1 to 3. However, the multilayer electronic component 100 may not be limited to the first to third shapes, and the shape and number of internal electrodes and external electrodes may vary depending on a mounting position or use.

The multilayer electronic component 100 may include the body 110 including the dielectric layer 111 and the first and second internal electrodes 121 and 122 alternately disposed with the dielectric layer 111 interposed therebetween and the external electrodes 131 and 132 disposed on the body 110.

In the body 110, the dielectric layer 111 and the internal electrodes 121 and 122 are alternately stacked.

The body 110 is not particularly limited to a specific shape, but as shown, the body 110 may have a hexahedral shape or a shape similar thereto. Due to shrinkage of the ceramic powder included in the body 110 during sintering, the body 110 may not have a hexahedral shape with perfect straight lines but a substantially hexahedral shape.

The body 110 may include first and first surfaces 1 and 2 facing each other in the first direction, third and fourth surfaces connected to the first and second surfaces 1 and 2 and facing each other in the second direction, and the first and second side surfaces S1 and S2 connected to the surfaces 3 and 4 and facing each other in the third direction.

A plurality of dielectric layers 111 forming the body 110 are in a sintered state, and adjacent dielectric layers 111 may be integrated such that boundaries therebetween may not be readily apparent without using a scanning electron microscope (SEM).

According to an exemplary embodiment in the present disclosure, a material for forming the dielectric layer 111 is not limited as long as sufficient electrostatic capacity may be obtained. For example, a barium titanate-based material, a lead composite perovskite-based material, or a strontium titanate-based material may be used. The barium titanate-based material may include a BaTiO₃-based ceramic powder, and the ceramic powder may include BaTiO₃ and (Ba₁₋ₓCaₓ) TiO₃, Ba (Ti_{1-y}Ca_{y}) O₃, (Ba₁₋ₓCaₓ) (Ti_{1-y}Zr_{y}) O₃, or Ba (Ti_{1-y}Zr_{y})O₃ obtained by partially dissolving calcium (Ca), zirconium (Zr), and the like in BaTiO₃.

In addition, various ceramic additives, organic solvents, binders, dispersing agents, etc. may be added to powder, such as barium titanate (BaTiO₃) as a raw material forming the dielectric layer 111 according to the purpose of the present disclosure.

The body 110 may include a capacitance forming portion Ac disposed inside the body 110 and including the first internal electrodes 121 and the second internal electrodes 122 alternately disposed with the dielectric layer 111 therebetween and cover portions 112 and 113 respectively formed on upper and lower surfaces of the capacitance forming portion Ac in the first direction.

In addition, the capacitance forming portion may be a portion that contributes to formation of capacitance of the capacitor, and may be formed by repeatedly stacking a plurality of first and second internal electrodes 121 and 122 with the dielectric layer 111 interposed therebetween.

The cover portions 112 and 113 may include the upper cover portion 112 disposed above the capacitance forming portion Ac in the first direction and the lower cover portion 113 disposed below the capacitance forming portion Ac in the first direction.

The upper cover portion 112 and the lower cover portion 113 may be formed by stacking a single dielectric layer or two or more dielectric layers on the upper and lower surfaces of the capacitance forming portion Ac in the thickness direction, respectively, and may basically serve to prevent damage to the internal electrodes due to physical or chemical stress.

The upper cover portion 112 and the lower cover portion 113 may not include internal electrodes and may include the same material as that of the dielectric layer 111.

That is, the upper cover portion 112 and the lower cover portion 113 may include a ceramic material, for example, a barium titanate (BaTiO₃)-based ceramic material.

In addition, margin portions 114 and 115 may be disposed on side surfaces of the capacitance forming portion Ac.

The margin portions 114 and 115 may include a margin portion 114 disposed on the first side surface S1 of the body 110 and a margin portion 115 disposed on the second side surface S2 of the body 110. That is, the margin portions 114 and 115 may be disposed on both end surfaces of the body 110 in the third direction.

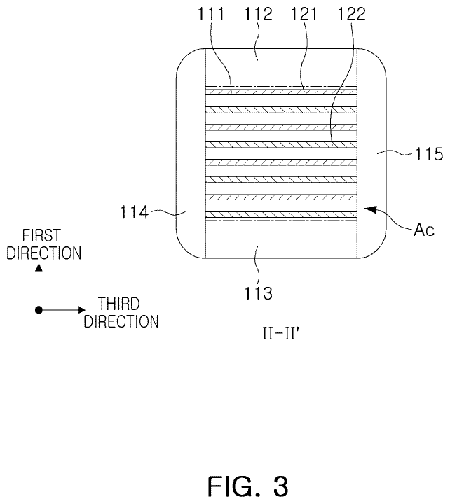

As shown in FIG. 3, the margin portions 114 and 115 may refer to a region between both ends of the first and second internal electrodes 121 and 122 and a boundary surface of the body 110 in a cross-section of the body 110 taken in a width-thickness (W-T) direction.

The margin portions 114 and 115 may basically serve to prevent damage to the internal electrodes due to physical or chemical stress.

According to an exemplary embodiment in the present disclosure, in order to suppress a step difference due to the internal electrodes 121 and 122, after stacking, the internal electrodes may be cut to be exposed to the first and second side surfaces S1 and S2 of the body, and then a single dielectric layer or two or more dielectric layers may be stacked on both side surfaces of the capacitance forming portion Ac in the third direction to form the margin portions 114 and 115.

A width of the margin portions 114 and 115 may not be particularly limited. However, an average width of the margin portions 114 and 115 may be 15 μm or less in order to more easily achieve miniaturization and high capacitance of the multilayer electronic component. In addition, according to an exemplary embodiment in the present disclosure, after separating the unit chips from the support film in a direction in which the ceramic green sheets are stacked, an arrangement operation of moving the unit chips in a direction, perpendicular to the direction in which the unit chips are separated, and arranging the unit chips such that the second side surface of the unit chip is in contact with an adhesive tape is included, thereby manufacturing the multilayer electronic component having improved reliability, and thus, excellent reliability may be secured even when the average width of the margin portions 114 and 115 is 15 μm or less.

The average width of the margin portions 114 and 115 may refer to an average size of the margin portions 114 and 115 in the third direction, and may be a value obtained by averaging sizes of the margin portions 114 and 115 measured from five equally spaced points on the side surface of the capacitance forming portion Ac in the third direction.

The plurality of internal electrodes 121 and 122 may be alternately disposed with the dielectric layer 111 interposed therebetween.

The plurality of internal electrodes 121 and 122 may include first and second internal electrodes 121 and 122. The first and second internal electrodes 121 and 122 may be alternately disposed to face each other with the dielectric layer 111 constituting the body 110 interposed therebetween, and may be connected to the third and fourth surfaces 3 and 4 of the body 110, respectively.

Specifically, one end of the first internal electrode 121 may be connected to the third surface 3, and one end of the second internal electrode 122 may be connected to the fourth surface 4.

The first internal electrode 121 may be spaced apart from the fourth surface 4 and exposed through the third surface 3, and the second internal electrode 122 may be spaced apart from the third surface 3 and exposed through the fourth surface 4. The first external electrode 131 may be disposed on the third surface 3 of the body and connected to the first internal electrode 121, and the second external electrode 132 may be disposed on the fourth surface 4 of the body and connected to the second internal electrode 122.

That is, the first internal electrode 121 may not be connected to the second external electrode 132 and may be connected to the first external electrode 131, and the second internal electrode 122 may not be connected to the first external electrode 131 and may be connected to the second external electrode 132. Accordingly, the first internal electrode 121 may be formed to be spaced apart from the fourth surface 4 by a predetermined distance, and the second internal electrode 122 may be formed to be spaced apart from the third surface 3 by a predetermined distance.

In this case, the first and second internal electrodes 121 and 122 may be electrically separated from each other by the dielectric layer 111 disposed therebetween.

The body 110 may be formed by alternately stacking the ceramic green sheet 201 on which the first internal electrode pattern 221 is printed and the ceramic green sheet 202 on which the second internal electrode pattern 222 is printed, and then sintering the same.

Materials forming the internal electrodes 121 and 122 are not particularly limited, and materials having excellent electrical conductivity may be used. For example, the internal electrodes 121 and 122 may include one or more of nickel (Ni), copper (Cu), palladium (Pd), silver (Ag), gold (Au), platinum (Pt), tin (Sn), tungsten (W), titanium (Ti), and alloys thereof.

In addition, the internal electrodes 121 and 122 may be formed by printing a conductive paste for an internal electrode including at least one of nickel (Ni), copper (Cu), palladium (Pd), silver (Ag), gold (Au), platinum (Pt), tin (Sn), tungsten (W), titanium (Ti), and alloys thereof on a ceramic green sheet. A screen-printing method or a gravure-printing method may be used as a method of printing the conductive paste for an internal electrode, but the present disclosure is not limited thereto.

The external electrodes 131 and 132 may be disposed on the third and fourth surfaces 3 and 4 of the body 110, respectively, and the first external electrode 131 may be electrically connected to the first internal electrode 121 and the second external electrode 132 may be electrically connected to the second internal electrode 122.

In the present exemplary embodiment, a structure in which the multilayer electronic component 100 includes two external electrodes 131 and 132 is described, but the number and shape of the external electrodes 131 and 132 may change depending on the shape of the internal electrodes 121 and 122 or other purposes.

Meanwhile, the external electrodes 131 and 132 may be formed using any material having electrical conductivity, such as metal, and a specific material may be determined in consideration of electrical characteristics, structural stability, and the like, and the external electrodes 131 and 132 may further have a multilayer structure.

For example, the external electrodes 131 and 132 may include an electrode layer disposed on the surface of the body 110 to directly contact the internal electrodes 121 and 122 and a plating layer formed on the electrode layer.

As a specific example of the electrode layer, the electrode layer may be a sintered electrode including a conductive metal and glass or a resin-based electrode including a conductive metal and resin.

In addition, the electrode layer may have a form in which a sintered electrode and a resin-based electrode are sequentially formed on the body. Also, the electrode layer may be formed by transferring a sheet including a conductive metal onto the body or by transferring a sheet including a conductive metal onto a sintered electrode.

As the conductive metal included in the electrode layer, a material having excellent electrical conductivity may be used but is not particularly limited. For example, the conductive metal may be at least one of nickel (Ni), copper (Cu), and alloys thereof.

The plating layer serves to improve mounting characteristics. The type of the plating layer is not particularly limited, and may be a plating layer including at least one of Ni, Sn, Pd, and alloys thereof, and may be formed of a plurality of layers.

For a specific example of the plating layer, the plating layer may be a Ni plating layer or a Sn plating layer, may be a form in which a Ni plating layer and a Sn plating layer are sequentially formed on the electrode layer, and may be a form in which a Sn plating layer, a Ni plating layer, and a Sn plating layer are sequentially formed on the electrode layer. Further, the plating layer may include a plurality of Ni plating layers and/or a plurality of Sn plating layers.

As set forth above, according to an exemplary embodiment, the side margin portions may be efficiently formed in the multilayer electronic component. For example, the occurrence of defects in the process of attaching the side margin portion to the multilayer electronic component may be efficiently prevented.

While exemplary embodiments have been shown and described above, it will be apparent to those skilled in the art that modifications and variations could be made without departing from the scope of the present disclosure as defined by the appended claims.

What is claimed is:

1. A method of manufacturing a multilayer electronic component, the method comprising:
cutting a stack, in which a plurality of internal electrode patterns and a plurality of ceramic green sheets are alternately stacked in a stacking direction, in the stacking direction to obtain a plurality of unit chips; and
attaching a portion of a ceramic green sheet for a side margin portion to the plurality of unit chips in a direction, different from the stacking direction,
wherein the attaching includes attaching the portion of the ceramic green sheet for a side margin portion to the plurality of unit chips by compression between a first elastic body on which the ceramic green sheet for a side margin portion is disposed and the plurality of unit chips,
the first elastic body includes a first elastic layer having a first elastic modulus and a second elastic layer having a second elastic modulus, different from the first elastic modulus, and disposed between the plurality of unit chips and the first elastic layer, and
an elastic modulus of the first elastic body is greater than 50 MPa and less than or equal to 1000 MPa.

2. The method of claim 1, wherein each of the first and second elastic modulus exceeds 50 MPa.

3. The method of claim 1, wherein
the second elastic modulus is higher than the first elastic modulus, and
a thickness of the first elastic layer is greater than a thickness of the second elastic layer.

4. The method of claim 3, wherein
the first elastic layer includes a non-woven fabric,
the second elastic layer includes polyethylene terephthalate (PET),
the thickness of the first elastic layer is greater than 0 μm and less than or equal to 2 μm, and
the thickness of the second elastic layer is greater than 0 μm and less than or equal to 1 μm.

5. The method of claim 1, wherein each of the first and second elastic layers includes at least one of silicone, polyethylene terephthalate (PET), polyurethane (PU), natural rubber, polyolefin (PO), and nonwoven fabric.

6. The method of claim 1, wherein
a thickness of each of the first and second elastic layers is greater than 0 μm and less than or equal to 3 μm, and
roughness of a surface of the second elastic layer facing the ceramic green sheet for a side margin portion is greater than roughness of surfaces of the first and second elastic layers facing each other.

7. The method of claim 1, wherein
the attaching further includes rotating the plurality of unit chips disposed on a second elastic body before the ceramic green sheet for a side margin portion is disposed on the first elastic body, and
the second elastic body includes a third elastic layer having a third elastic modulus and a fourth elastic layer having a fourth elastic modulus, different from the third elastic modulus, and disposed between at least one of the plurality of unit chips and the third elastic layer.

8. The method of claim 1, wherein
the attaching includes attaching the portion of the ceramic green sheet for a side margin portion to the plurality of unit chips by compression between the first elastic body and a second elastic body, after the plurality of unit chips are disposed between the first elastic body and the second elastic body, and
the second elastic body includes a third elastic layer having a third elastic modulus and a fourth elastic layer having a fourth elastic modulus, different from the third elastic modulus, and disposed between the plurality of unit chips and the third elastic layer.

9. A method of manufacturing a multilayer electronic component, the method comprising:
cutting a stack, in which a plurality of internal electrode patterns and a plurality of ceramic green sheets are alternately stacked in a stacking direction, in the stacking direction to obtain a plurality of unit chips; and
attaching a portion of a ceramic green sheet for a side margin portion to the plurality of unit chips in a direction, different from the stacking direction,
wherein the attaching includes attaching the portion of the ceramic green sheet for a side margin portion to the plurality of unit chips by compression between a first elastic body on which the ceramic green sheet for a side margin portion is disposed and the plurality of unit chips,
the first elastic body includes a first elastic layer having a first elastic modulus and a second elastic layer having a second elastic modulus, different from the first elastic modulus, and disposed between the plurality of unit chips and the first elastic layer,
the attaching further includes rotating the plurality of unit chips disposed on a second elastic body before the ceramic green sheet for a side margin portion is disposed on the first elastic body, and
the second elastic body includes a third elastic layer having a third elastic modulus and a fourth elastic layer having a fourth elastic modulus, different from the third elastic modulus, and disposed between the plurality of unit chips and the third elastic layer.

10. The method of claim 9, wherein each of the first, second, third and fourth elastic modulus exceeds 50 MPa.

11. The method of claim 9, wherein
the second elastic modulus is higher than the first elastic modulus,
a thickness of the first elastic layer is greater than a thickness of the second elastic layer,
the fourth elastic modulus is higher than the third elastic modulus, and
a thickness of the third elastic layer is greater than a thickness of the fourth elastic layer.

12. The method of claim 11, wherein
each of the first and third elastic layers includes nonwoven fabric,
each of the second and fourth elastic layers includes polyethylene terephthalate (PET),
the thickness of each of the first and third elastic layers is greater than 0 μm and less than or equal to 2 μm, and
the thickness of each of the second and fourth elastic layers is greater than 0 μm and less than or equal to 1 μm.

13. The method of claim 9, wherein each of the first, second, third, and fourth elastic layers includes at least one of silicone, polyethylene terephthalate (PET), polyurethane (PU), natural rubber, polyolefine (PO), and nonwoven fabric.

14. The method of claim 9, wherein
a thickness of each of the first, second, third, and fourth elastic layers is greater than 0 μm and less than or equal to 3 μm,
roughness of a surface of the second elastic layer facing the ceramic green sheet for a side margin portion is greater than roughness of surfaces of the first and second elastic layers facing each other, and
roughness of a surface of the fourth elastic layer facing at least one of the plurality of unit chips is greater than roughness of surfaces of the third and fourth elastic layers facing each other.

15. A method of manufacturing a multilayer electronic component, the method comprising:
cutting a stack, in which a plurality of internal electrode patterns and a plurality of ceramic green sheets are alternately stacked in a stacking direction, in the stacking direction to obtain a plurality of unit chips; and
attaching a portion of a ceramic green sheet for a side margin portion to the plurality of unit chips in a direction, different from the stacking direction,
wherein the attaching includes attaching the portion of the ceramic green sheet for a side margin portion to the plurality of unit chips by compression between a first elastic body on which the ceramic green sheet for a side margin portion is disposed and the plurality of unit chips,
the first elastic body includes a first elastic layer having a first elastic modulus and a second elastic layer having a second elastic modulus, different from the first elastic modulus, and disposed between the plurality of unit chips and the first elastic layer,
the attaching includes attaching the portion of the ceramic green sheet for a side margin portion to the plurality of unit chips by compression between the first elastic body and a second elastic body, after the plurality of unit chips are disposed between the first elastic body and the second elastic body, and
the second elastic body includes a third elastic layer having a third elastic modulus and a fourth elastic layer having a fourth elastic modulus, different from the third elastic modulus, and disposed between the plurality of unit chips and the third elastic layer.

16. The method of claim 15, wherein each of the first, second, third and fourth elastic modulus exceeds 50 MPa.

17. The method of claim 15, wherein
the second elastic modulus is higher than the first elastic modulus,
a thickness of the first elastic layer is greater than a thickness of the second elastic layer,
the fourth elastic modulus is higher than the third elastic modulus, and
a thickness of the third elastic layer is greater than a thickness of the fourth elastic layer.

18. The method of claim 17, wherein
each of the first and third elastic layers includes nonwoven fabric,
each of the second and fourth elastic layers includes polyethylene terephthalate (PET),
the thickness of each of the first and third elastic layers is greater than 0 μm and less than or equal to 2 μm, and
the thickness of each of the second and fourth elastic layers is greater than 0 μm and less than or equal to 1 μm.

19. The method of claim 15, wherein each of the first, second, third, and fourth elastic layers includes at least one of silicone, polyethylene terephthalate (PET), polyurethane (PU), natural rubber, polyolefine (PO), and nonwoven fabric.

20. The method of claim 15, wherein
a thickness of each of the first, second, third, and fourth elastic layers is greater than 0 μm and less than or equal to 3 μm,
roughness of a surface of the second elastic layer facing the ceramic green sheet for a side margin portion is greater than roughness of surfaces of the first and second elastic layers facing each other, and
roughness of a surface of the fourth elastic layer facing at least one of the plurality of unit chips is greater than roughness of surfaces of the third and fourth elastic layers facing each other.
